(19) United States
(12) Patent Application Publication
(10) Pub. No.: US 2009/0148189 A1
(43) Pub. Date: Jun. 11, 2009

(54) Developing Device, Developing Method, and Image Forming Apparatus

(75) Inventor: Masahiro FUKAZAWA, Chino-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/330,328

(22) Filed: Dec. 8, 2008

(30) Foreign Application Priority Data
Dec. 11, 2007 (JP) 2007-319140
Oct. 17, 2008 (JP) 2008-268156

(51) Int. Cl. G03G 15/10

(52) U.S. Cl. 399/238

(57) ABSTRACT

A developing device includes: a supply storage section storing liquid developer including toner and carrier liquid; an application roller applying the liquid developer stored in the supply storage section; a developing roller supplied with the liquid developer by the application roller; a developing roller cleaning blade coming in contact with the developing roller and removing the liquid developer supplied to the developing roller; a recovery storage section storing the liquid developer removed by the developing roller cleaning blade; a wall portion configured to partition the supplied storage section and the recovery storage section from each other and having a first wall height portion higher than a lower portion of the application roller in the vertical direction and a second wall height portion lower than the lower portion in the vertical direction; and an auger transporting the liquid developer stored in the supply storage section.

### BACKGROUND

1. Technical Field

The present invention relates to a developing device and a developing method of developing a latent image formed on an image carrying member by the use of liquid developer including toner and carrier and an image forming apparatus for transferring a developed image formed of toner and carrier by a developing device to a recording medium and fusing and fixing the transferred toner image to form an image.

2. Related Art

A variety of wet image forming apparatuses for developing a latent image by the use of high-viscosity liquid developer in which toner including solid components is dispersed in a liquid solvent to visualize an electrostatic latent image has been suggested. The developer used in the wet image forming apparatuses is obtained by suspending solid powder (toner particles) in a high-viscosity organic solvent (carrier liquid) such as silicon oil, mineral oil and edible oil having an electrical insulation property and the toner particles are very minute with a particle diameter of about 1 μm. By using the minute toner particles, the wet image forming apparatuses can enhance the image quality more than dry image forming apparatuses using powder-like toner particles with a particle diameter of about 7 μm.

An example of the image forming apparatus using the above-mentioned liquid developer is disclosed in JP-A-2000-235306. In JP-A-2000-235306, a liquid ring formed by rollers or blades is considered as a problem of a developing device and an image forming apparatus using the liquid developer. In the technique described in JP-A-2000-235306, a relation of (length of application area 23a)<(length in width direction of cleaning blade 25)<(length of developing roller 22)<(length of application roller 23) is set to solve the problem with the liquid ring and the liquid ring 28 generated on the developing roller 22 corresponding to both ends of the cleaning blade 25 is removed by the use of a contact portion 29 with a stepped roller portion 23b which is a non-application area of the application roller 23.

However, in the image forming apparatus described in JP-A-2000-235306, the application roller 23 is always immersed in the liquid developer in a developer containing tank 21. For example, when the image forming apparatus is deactivated for a long time, the toner component of the liquid developer coheres and adheres to the application roller 23 in a portion where the application roller 23 contacts with an interface of the liquid developer to form a line-shaped mark in the axis direction of the application roller 23. Accordingly, when the image forming apparatus is restarted, the image quality is deteriorated due to the line-shaped mark. The line-shaped mark is different from the liquid ring and can be said to be a problem caused because the developer is liquid.

In the image forming apparatus described in JP-A-2000-235306, even when the problem with the liquid ring has been solved at the time of developing, there is a problem in that the liquid developer removed from the stepped roller portion 23b is saturated in a short time to form a liquid ring at the end of the stepped roller portion 23b.

When such a liquid ring is formed in the developing device or the image forming apparatus, the liquid developer gathered as the liquid ring during the deactivation of the device or apparatus is dropped to the lower portion of the device or apparatus, thereby causing contamination or trouble. The toner component in the liquid ring is solidified during the deactivation of the device or apparatus to secure the roller and the blade with each other, thereby causing a problem with damage on the surface of the roller or the blade.

### SUMMARY

According to an aspect of the invention, there is provided a developing device including: a supply storage section storing liquid developer including toner and carrier liquid; an application roller applying the liquid developer stored in the supply storage section; a developing roller supplied with the liquid developer by the application roller; a developing roller cleaning blade coming in contact with the developing roller and removing the liquid developer supplied to the developing roller; a recovery storage section storing the liquid developer removed by the developing roller cleaning blade; a wall portion configured to partition the supply storage section and the recovery storage section from each other and having a first wall height portion higher than a lower portion of the application roller in the vertical direction and a second wall height portion lower than the lower portion in the vertical direction; and an auger transporting the liquid developer stored in the supply storage section.

In the developing device, the rotation center of the auger may be closer to the wall portion than the rotation center of the application roller is.

The developing device may further include a control blade coming in trail contact with the application roller to control an amount of liquid developer.

In the developing device, the axis-direction length of the application roller may be greater than the length of the first wall height portion in the axis direction of the application roller.

In the developing device, the second wall height portion may be disposed at ends in the axis direction of the application roller.

In the developing device, the application roller may come in contact with the developing roller.

According to another aspect of the invention, there is provided a developing method of raising the liquid level of liquid developer stored in a supply storage section by rotation of an auger disposed in the supply storage section to bring the liquid developer into contact with an application roller and transporting the liquid developer to a recovery storage section partitioned from the supply storage section by a wall portion.

In the developing method, the wall portion may have a first wall height portion higher than the bottom surface of the application roller in the vertical direction and a second wall height portion lower than the bottom surface of the application roller in the vertical direction, the liquid developer is brought into contact with the application roller in the supply storage section corresponding to the first wall height portion, and the liquid developer may be transported to the recovery storage section in the supply storage section corresponding to the second wall height portion.

In the developing method, an amount of liquid developer to be applied may be controlled by a control blade coming in trail contact with the application roller.

In the developing method, the application roller may apply the liquid developer onto a developing roller coming in contact with the application roller.

In the developing method, a rotational tangent direction of the top surface of the auger in the vertical direction may be directed to the wall portion.

According to still another aspect of the invention, there is provided an image forming apparatus including: an image carrying member; a charging unit charging the image carrying member; an exposure unit forming a latent image on the image carrying member charged by the charging unit; a developing unit including a developing roller, an application roller applying liquid developer onto the developing roller, a developing roller cleaning member removing the liquid developer applied onto the developing roller, and a supply storage section storing the liquid developer and developing the latent image formed on the image carrying member; a transfer unit transferring the developed image on the image carrying member to a transfer medium; a recovery storage section recovering the liquid developer removed by the developing roller cleaning member; and a wall portion partitioning the supply storage section from the recovery storage section and having a first wall height portion higher than the bottom surface of the application roller in the vertical direction and a second wall height portion lower than the bottom surface of the application roller in the vertical direction.

The image forming apparatus may further include a concentration control storage section supplying the liquid developer to the supply storage section and recovering the liquid developer stored in the recovery storage section to control the concentration of the liquid developer.

The image forming apparatus may further include a toner storage section supplying the liquid developer, which includes toner and carrier liquid, to the concentration control storage section and a carrier storage section storing the carrier liquid supplied to the concentration control storage section.

The image forming apparatus may further include an agitating portion agitating the liquid developer stored in the concentration control storage section.

According to the aspects of the invention, since the application roller does not come in contact with the liquid developer at the time of the deactivation of the image forming apparatus, it is possible to prevent the toner component of the liquid developer from cohering and adhering to the application roller. Accordingly, the line-shaped mark is not formed in the axis direction of the application roller, thereby not causing the deterioration in image quality due to the line-shaped mark.

According to the aspects of the invention, it is possible to suppress the amount of liquid developer applied to both end portions of the developing roller, thereby suppressing the formation of a liquid ring as much as possible. Accordingly, the inside of the apparatus is not contaminated by the drop of the liquid developer from the liquid ring, thereby reducing the consumption of liquid developer.

The following aspect of the invention is also effective. That is, according to an aspect of the invention, there is provided a film forming apparatus including: an application roller forming a film of liquid developer on a predetermined member; a liquid developer container disposed below the application roller; a supply storage section disposed in the liquid developer container to supply the liquid developer to be applied to the application roller; a recovery storage section disposed in parallel to the supply storage section of the liquid developer container; a partition section partitioning the supply storage section and the recovery storage section from each other; and an auger disposed in the supply storage section to transport the liquid developer, wherein a first height area and a second height area are formed in the longitudinal direction in the partition wall, the first height is set to be greater than the second height, the liquid level of the liquid developer at the time of deactivation is set to be smaller than the height of the bottom surface of the application roller, a rotational tangent direction of the top surface of the auger at the time of operation is directed to the partition section, and a rotational tangent direction of the bottom surface of the application roller is directed to be apart from the partition wall, thereby supplying the liquid developer from the auger to the application roller.

In the film forming apparatus, the distance between the rotation center of the auger and the partition section may be smaller than the distance between the rotation center of the application roller and the partition section.

The film forming apparatus may further include a control blade coming in contact with the application roller to control an amount of liquid developer applied onto the developing roller and the control blade may come in trail contact with the application roller.

In the film forming apparatus, the liquid level of the liquid developer in the supply storage section may be determined to be the second height.

In the film forming apparatus, the length in the longitudinal direction of the application roller may be set to be greater than the length in the longitudinal direction of the first height area.

In the film forming apparatus, the second height area of the partition section may be disposed at ends in the longitudinal direction of the partition section.

According to another aspect of the invention, there is provided a developing device employing the film forming apparatus

According to still another aspect of the invention, there is provided an image forming apparatus including: a developing roller developing an electrostatic latent image formed on an image carrying member; a unit transferring the developed image on the image carrying member to a recording medium, an application roller applying liquid developer onto the developing roller; a liquid developer container disposed below the application roller; a supply storage section disposed in the liquid developer container to supply the liquid developer to be applied to the application roller; a recovery storage section disposed in parallel to the supply storage section of the liquid developer container; a partition section partitioning the supply storage section and the recovery storage section from each other; and an auger disposed in the supply storage section to transport the liquid developer, wherein a first height area and a second height area are formed in the longitudinal direction in the partition wall, the first height is set to be greater than the second height, the liquid level of the liquid developer at the time of deactivation is set to be smaller than the height of the bottom surface of the application roller, a rotational tangent direction of the top surface of the auger at the time of operation is directed to the partition section, and a rotational tangent direction of the bottom surface of the application roller is directed to be apart from the partition section, thereby supplying the liquid developer from the auger to the application roller.

According to the aspects of the invention, it is possible to suppress the amount of liquid developer applied to both ends of the developing roller, thereby suppressing the formation of the liquid ring as much as possible. Accordingly, the inside of the apparatus is not contaminated by the drop of the liquid developer from the liquid ring, thereby reducing the consumption of the liquid developer.

### BRIEF DESCRIPTION OF THE DRAWINGS

The invention will be described with reference to the accompanying drawings, wherein like numbers reference like elements.

FIG. 1 is a diagram illustrating primary elements of an image forming apparatus according to an embodiment of the invention.

FIG. 2 is a sectional view illustrating primary elements of an image forming section and a developing device.

FIG. 3 is a perspective view illustrating an anilox roller used in the embodiment of the invention.

FIG. 4 is a diagram illustrating a relation between a groove area of the anilox roller and an image forming area.

FIG. 5 is a perspective view illustrating a developer container used in the embodiment of the invention and a relevant configuration thereof.

FIG. 6 is a perspective view illustrating an auger used in the embodiment of the invention.

FIGS. 7A and 7B are diagrams illustrating a state where the developing device according to the embodiment of the invention is deactivated and a state where the developing device is activated, respectively.

FIG. 8 is a diagram illustrating a size relation in the longitudinal direction of rollers and the like in the developing device according to the embodiment of the invention.

FIG. 9 is a diagram illustrating a sectional size relation of a developer container of the developing device according to the embodiment of the invention.

FIGS. 10A, 10B, and 10C are diagrams schematically illustrating various types of partitioning a supply storage section and a recovery storage section from each other in the developer container.

FIGS. 11A to 11F are diagrams illustrating various types of partition sections of the developing device and the image forming apparatus according to the embodiment of the invention.

FIG. 12 is a diagram schematically illustrating flows of liquid developer flowing in the developer container and liquid developer flowing out of the developer container.

FIG. 13 is a diagram illustrating primary elements of an image forming apparatus according to another embodiment of the invention.

FIG. 14 is a diagram illustrating a size relation in the longitudinal direction of rollers and the like in a developing device according to the embodiment of the invention.

FIGS. 15A, 15B, and 15C are sectional views illustrating primary elements of the image forming section and the developing device according to the embodiment of the invention.

FIG. 16 is a diagram illustrating a developer recycling mechanism according to another embodiment of the invention.

### DESCRIPTION OF EXEMPLARY EMBODIMENTS

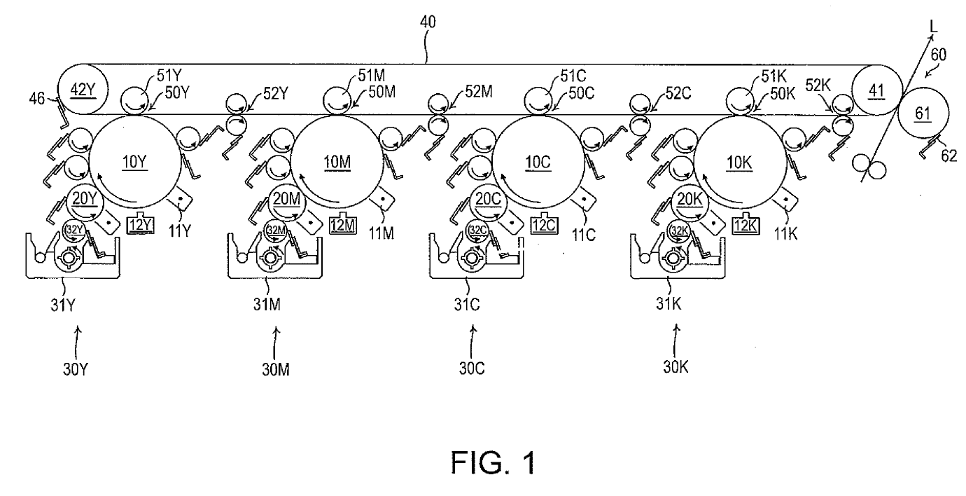

Hereinafter, embodiments of the invention will be described with reference to the accompanying drawings. FIG. 1 is a diagram illustrating primary elements of an image forming apparatus according to an embodiment of the invention. In image forming sections of respective colors disposed at the center of the image forming apparatus, developing devices 30Y, 30M, 30C, and 30K are disposed in the lower portion of the image forming apparatus and an intermediate transfer member 40 and a secondary transfer section 60 (secondary transfer unit) are disposed in the upper portion of the image forming apparatus.

The image forming sections includes image carriers 10Y, 10M, 10C, and 10K, corona chargers 11Y, 11M, 11C, and 11K, and exposure units 12Y, 12M, 12C, and 12K not shown. The exposure units 12Y, 12M, 12C, and 12K have an optical system of a semiconductor laser, a polygon mirror, an F-θ lens, and the like, uniformly charge the image carriers 10Y, 10M, 10C, and 10K by the use of the corona chargers 11Y, 11M, 11C, and 11K, and apply modulated laser beams by the use of the exposure units 12Y, 12M, 12C, and 12K on the basis of input image signals, thereby forming electrostatic latent images on the charged image carriers 10Y, 10M, 10C, and 10K.

The developing devices 30Y, 30M, 30C, and 30K include developing rollers 20Y, 20M, 20C, and 20K, developer containers (reservoirs) 31Y, 31M, 31C, and 31K storing liquid developer of yellow (Y), magenta (M), cyan (C), and black (K) colors, and anilox rollers 32Y, 32M, 32C, and 32K as application rollers applying the liquid developer of the respective colors onto the developing rollers 20Y, 20M, 20C, and 20K from the developing containers 31Y, 31M, 31C, and 31K, respectively, and develop the electrostatic latent images formed on the image carriers 10Y, 10M, 10C, and 10K by the use of the liquid developer of the respective colors.

The intermediate transfer member 40 is an endless belt and is suspended between a driving roller 41 and a tension roller 42 and is rotationally driven by the driving roller 41 while coming in contact with the image carriers 10Y, 10M, 10C, and 10K in primary transfer sections 50Y, 50M, 50C, and 50K, respectively. In the primary transfer sections 50Y, 50M, 50C, and 50K, primary transfer rollers 51Y, 51M, 51C, and 51K are opposed to the image carriers 10Y, 10M, 10C, and 10K with the intermediate transfer member 40 interposed therebetween and toner images of the respective colors on the image carriers 10Y, 10M, 10C, and 10K are sequentially transferred onto the intermediate transfer member 40 in an overlapping manner at positions contact with the image carriers 10Y, 10M, 10C, and 10K as transfer positions, thereby forming a full-color toner image.

In the secondary transfer unit 60, a secondary transfer roller 61 is opposed to the belt driving roller 41 with the intermediate transfer member 40 interposed therebetween and a cleaning device including a secondary transter roller cleaning blade 62 is provided. At the transfer position where the secondary transfer roller 61 is disposed, a single-color toner image or a full-color toner image formed on the intermediate transfer member 40 is transferred to a recording medium such as a sheet, a film, and a cloth transported in a sheet transport path L.

A fixing unit 90 is disposed downstream in the sheet transport path L so as to fuse and fix the single-color toner image or the full-color toner image transferred onto the recording medium such as a sheet to the recording medium such as a sheet.

The tension roller 42 goes over the intermediate transfer member 40 along with the belt driving roller 41 and a cleaning device including an intermediate transfer member cleaning blade 46 is disposed to be in contact therewith at a position where the tension roller 42 of the intermediate transfer member 40 is suspended.

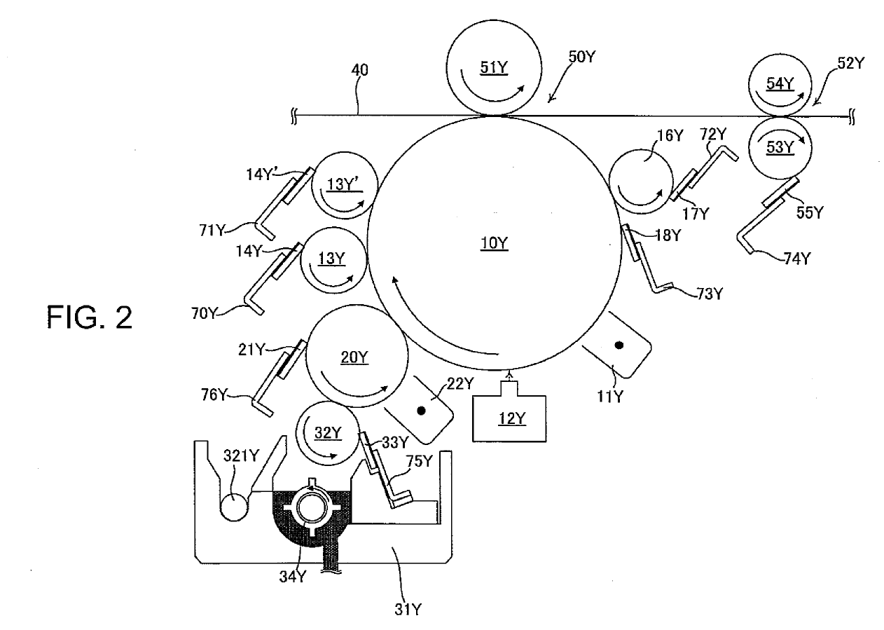

The image forming sections and the developing devices of the image forming apparatus according to the embodiment of the invention will be described now. FIG. 2 is a sectional view illustrating primary elements of the image forming sections and the developing devices. Since the image forming sections and the developing devices for the colors are equal to each other, the image forming section and the developing device for yellow (Y) will be mainly described now.

In the image forming section, a carrier recovery roller 16Y, an image carrier cleaning blade 18Y, a corona charger 11Y, an exposure unit 12Y, a developing roller 20Y of the developing device 30Y, an image carrier squeeze roller 13Y, and an image carrier squeeze roller 13Y′ are disposed in the peripheral rotation direction of the image carrier 10Y. Reference numeral 17Y represents a carrier recovery roller cleaning blade cleaning the carrier recovery roller 16Y. The image carrier squeeze rollers 13Y and 13Y′ include cleaning devices such as image carrier squeeze roller cleaning blades 14Y and 14Y′ as an appurtenant Reference numerals 70Y, 71Y, 72Y, and 73Y represent cleaning blade holding members holding the cleaning blades.

A cleaning blade 21Y, an anilox roller 32Y, and a toner compressing corona generator 22Y are disposed in the outer periphery of the developing roller 20Y in the developing device 30Y. A control blade 33Y controlling an amount of liquid developer supplied to the developing roller 20Y comes in contact with the anilox roller 32Y. Reference numeral 75Y represents a blade holding member holding the control blade 33Y.

A liquid developer auger 34Y and a recovery screw 321Y are received in the liquid developer container 31Y.

A primary transfer roller 51Y as the primary transfer section is disposed at a position opposed to the image carrier 10Y along the intermediate transfer member 40, and an intermediate transfer member squeeze roller 53Y, a backup roller 54Y, and an intermediate transfer member squeeze device 52Y including an intermediate transfer member squeeze roller cleaning blade 55Y are disposed downstream in the moving direction of the intermediate transfer member.

The image carrier 10Y is a photosensitive drum having a width greater than that of the developing roller 20Y and being formed of a cylindrical member having a photosensitive layer formed on the periphery thereof and rotates counterclockwise as shown in FIG. 2. The photosensitive layer of the image carrier 10Y is formed of an organic image carrier or an amorphous silicon image carrier. The corona charger 11Y is disposed upstream in the rotation direction of the image carrier 10Y from a nip portion between the image carrier 10Y and the developing roller 20Y and is supplied with a voltage from a power supply not shown to corona-charge the image carrier 10Y. The exposure unit 12Y is disposed downstream in the rotation direction of the image carrier 10Y from the corona charger 11Y and applies a laser beam to the image carrier 10Y charged by the corona charger 11Y to form a latent image on the image carrier 10Y.

From the start to the end of an image forming process, elements such as rollers disposed in the front stage are defined as being disposed upstream from elements such as rollers disposed in the rear stage.

The developing device 30Y includes a toner-compressing corona generator 22Y performing a compaction process and a developer container 31Y storing liquid developer in which about 20 wt % of toner is dispersed in carrier. The developer container 31Y includes a recovery screw 321Y recovering the liquid developer not supplied to the anilox roller 32Y.

The developing device 30Y includes a developing roller 20Y carrying the liquid developer, an anilox roller 32Y as the application roller applying the liquid developer onto the developing roller 20Y, a control blade 33Y controlling an amount of liquid developer applied to the developing roller 20Y, an auger 34Y supplying the liquid developer to the anilox roller 32Y while agitating and transporting the liquid developer, a toner-compressing corona generator 22Y making the liquid developer carried by the developing roller 20Y in a compaction state, and a developing roller cleaning blade 21Y cleaning the developing roller 20Y. Reference numeral 76Y represents a cleaning blade holding member holding the developing roller cleaning blade 21Y.

The liquid developer contained in the developer container 31Y is not volatile liquid developer having low concentration (1 to 2 wt %) and low viscosity and having a volatile property at a room temperature, which was generally used in the past and used Isopar (trademark: Exon) as carrier, but a nonvolatile liquid developer having high concentration and high viscosity and having a nonvolatile property at the room temperature. That is, the liquid developer used in the invention is high-viscosity (about 30 to 10,000 mPas) liquid developer of which the concentration of solid toner is set to be about 20% by adding solid powder with an average particle size of 1 μm, in which coloring agent such as pigment is dispersed in thermoplastic resin, to a liquid solvent such as organic solvent, silicon oil, mineral oil, or edible oil along with a dispersion agent.

The anilox roller 32Y serves as the application roller supplying and applying the liquid developer to the developing roller 20Y. The anilox roller 32Y is a roller in which unevenness formed of grooves carved in fine and uniform spiral patterns on the surface is formed on a cylindrical member so as to easily carry the developer. The liquid developer is supplied from the developer container 31Y to the developing roller 20Y by the anilox roller 32Y. At the time of operation of the apparatus, as shown in FIG. 2, the auger 34Y rotates counterclockwise to supply the liquid developer to the anilox roller 32Y and the anilox roller 32Y rotates counterclockwise to apply the liquid developer onto the developing roller 20Y.

The control blade 33Y is an elastic blade of which the surface is coated with an elastic material and includes a rubber portion formed of urethane rubber to come in contact with the surface of the anilox roller 32Y and a plate formed of metal to support the rubber portion. The control blade 33Y controls and adjusts the thickness and amount of liquid developer carried and transported by the anilox roller 32Y to adjust the amount of liquid developer supplied to the developing roller 20Y.

The developing roller 20Y has a cylindrical shape and rotates counterclockwise about a rotation axis as shown in FIG. 2. The developing roller 20Y is formed by disposing an elastic layer formed of polyurethane rubber, silicon rubber, or NBR on the periphery of a metal core formed of iron or the like. The developing roller cleaning blade 21Y is formed of rubber coming in contact with the surface of the developing roller 20Y, is disposed downstream in the rotation direction of the developing roller 20Y from a developing nip portion in which the developing roller 20Y comes in contact with the image carrier 10Y, and serves to scrub out the liquid developer remaining on the developing roller 20Y.

The toner-compressing corona generator 22Y is an electric field applying unit enhancing a charging bias on the surface of the developing roller 20Y. As shown in FIG. 2, the liquid developer transported by the developing roller 20Y is supplied at a toner compressed portion with an electric field from the toner-compressing corona generator 22Y to the developing roller 20Y by the toner-compressing corona generator 22Y.

The electric field applying unit for compressing the toner may employ a compaction roller instead of the corona discharge of the corona discharger shown in FIG. 2. The compaction roller is a kind of elastic roller formed by coating a cylindrical member with an elastic material similarly to the developing roller 20Y and has a structure in which a conductive resin layer or a rubber layer is disposed as a surface layer of a metal roller base. For example, the compaction roller is made to rotate in a clockwise direction which is opposite to the rotation direction of the developing roller 20Y.

On the other hand, the developer carried and compressed on the developing roller 20Y develops the latent image on the image carrier 10Y in the developing nip portion where the developing roller 20Y comes in contact with the image carrier 10Y, by applying a desired electric field thereto. The remaining developer is scrubbed out by the developing roller cleaning blade 21Y and is dropped on a recovery section in the developer container 31Y for reuse. The carrier and toner to be reused are not mixed with each other.

The image carrier squeeze device disposed upstream from the primary transfer position is disposed downstream from the developing roller 20Y to be opposed to the image carrier 10Y and recovers the surplus developer of the toner image developed on the image carrier 10Y. As shown in FIG. 2, the image carrier squeeze device includes the image carrier squeeze rollers 13Y and 13Y′ formed of an elastic roller member of which the surface is coated with an elastic material and which come in slidable contact with the image carrier 10Y to rotate and the cleaning blades 14Y and 14Y′ coming in press contact with the image carrier squeeze rollers 13Y and 13Y′ to clean the surfaces thereof and has a function of recovering surplus carrier and unnecessary foggy toner from the developer developed on the image carrier 10Y and enhancing the toner particle ratio in the developed image. The plural image carrier squeeze rollers 13Y and 13Y′ are provided as the image carrier squeeze device before the primary transfer, but only one image carrier squeeze roller may be provided. One of the plural image carrier squeeze rollers 13Y and 13Y′ may be configured to be contacted with and separated from the image carrier depending on the state of the liquid developer.

In the primary transfer section 50Y, the developer image developed on the image carrier 10Y is transferred to the intermediate transfer member 40 by the primary transfer roller 51Y. Here, the image carrier 10Y and the intermediate transfer member 40 move at the same speed, thereby reducing drive load of rotation and movement and suppressing a disturbance on the toner image developed on the image carrier 10Y.

The image carrier squeeze device disposed downstream from the primary transfer is disposed downstream from the primary transfer section 50Y to be opposed to the image carrier 10Y and serves to recover surplus developer mainly including the carrier on the image carrier 10Y before the electrostatic latent image. As shown in FIG. 2, the image carrier squeeze device includes a carrier recovery roller 16Y formed of an elastic roller member of which the surface is coated with an elastic material and which comes in slidable contact with the image carrier 10Y to rotate and a carrier recovery roller cleaning blade 17Y coming in press contact with the carrier recovery roller 16Y to clean the surface thereof and has a function of recovering the surplus carrier and the unnecessary toner not used for the transfer.

An image carrier cleaning blade 18Y completely cleaning the surface of the image carrier 10Y before forming a new electrostatic latent image thereon is disposed downstream from the carrier recovery roller 16Y.

The intermediate transfer member squeeze device 52Y is disposed downstream from the primary transfer section 50Y and performs a process of removing the surplus carrier from the intermediate transfer member 40 to enhance the toner particle ratio in the developed image.

Similarly to the image carrier squeeze device, the intermediate transfer member squeeze device 52Y includes an intermediate transfer member squeeze roller 53Y formed of an elastic roller member of which the surface is coated with an elastic material and which comes in slidable contact with the image carrier 40 to rotate, a backup roller 54Y disposed to be opposed to the intermediate transfer member squeeze roller 53Y with the image carrier 40 interposed therebetween, and a cleaning blade 55Y coming in press contact with the intermediate transfer member squeeze roller 53Y to clean the surface thereof, and has a function of recovering the surplus carrier and the unnecessary foggy toner from the developer primarily transferred onto the intermediate transfer member 40.

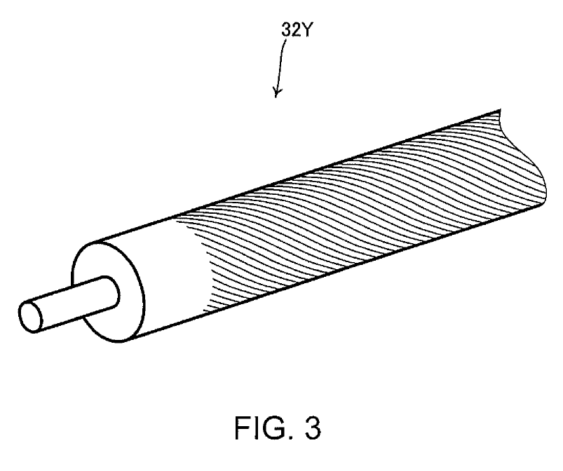

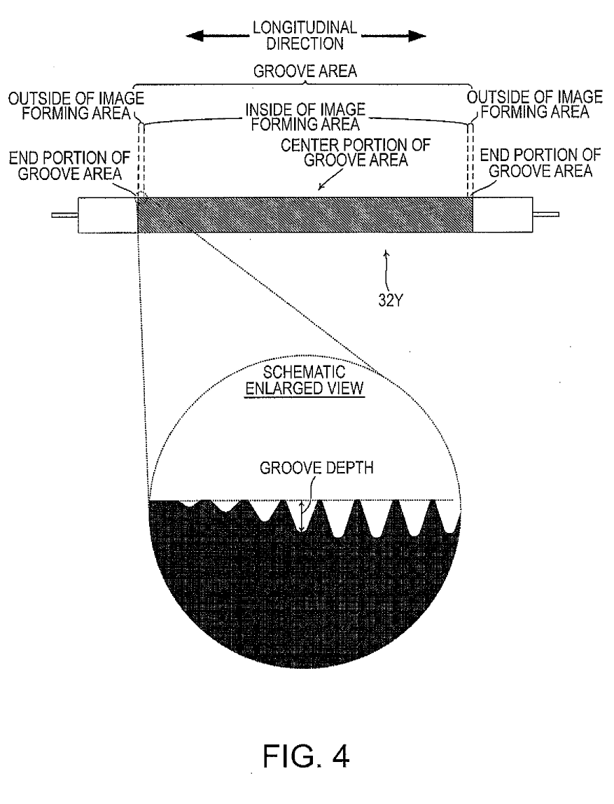

The detailed configuration of the application roller used for the developing device and the image forming apparatus according to the embodiment of the invention will be described now. FIG. 3 is a perspective view illustrating the anilox roller used in the embodiment and FIG. 4 is a diagram illustrating a relation between a groove area of the anilox roller used in the embodiment of the invention and an image forming area. As shown in FIG. 3, unevenness formed of grooves carved in fine and uniform spiral patterns on the surface is formed on the surface of the anilox roller 32Y so as to easily carry the developer. FIG. 4 illustrates the state of the grooves in more detail, where the upper portion is a view of the anilox roller 32Y as viewed in the longitudinal direction and the lower portion surrounded with a circle is a partial enlarged view of the anilox roller 32Y illustrated in the upper portion.

In the anilox roller 32Y, an area in which grooves are formed (hereinafter, referred to as “groove area”) is a portion other than roller end portions as shown in the drawing. The groove area of the anilox roller 32Y covers the entire range corresponding to an image forming area of the developing device or the image forming apparatus. However, as shown in the drawing, both end portions of the groove area of the anilox roller 32Y are set as a margin, namely outside the image forming area.

The partial enlarged view of one end portion of the groove area is shown in the lower circle of the drawing and the groove depth slowly increases from the end portion of the groove area to the center portion thereof as shown in the drawing. The right end portion of the groove area is symmetrically configured in the same way as the left end portion shown in the drawing. As viewed from the left side of the drawing, the groove depth is constant after becoming a certain depth and the constant depth is continued in the center portion of the groove area.

In this embodiment, since the groove depth of the end portions of the groove area is smaller than the groove depth of the center portion of the groove area, the amount (thickness) of liquid developer applied to the end portions of the developing roller 20Y is reduced, thereby suppressing the formation of a liquid ring.

In this embodiment, the end portions of the groove area having a small groove depth are disposed on the outer periphery of the anilox roller 32Y corresponding to the outside of the image forming area. When the shallow end portions are located inside the image forming area, the end portions of the image forming area get shallow, which can be prevented by the above-mentioned configuration.

In this embodiment, the groove depth increases from the end portion of the groove area to the center portion of the groove area. According to this configuration, it is possible to more easily perform the processing and manufacturing, compared with the groove structure where the groove depth rapidly increases at a certain point from the end portion to the center portion.

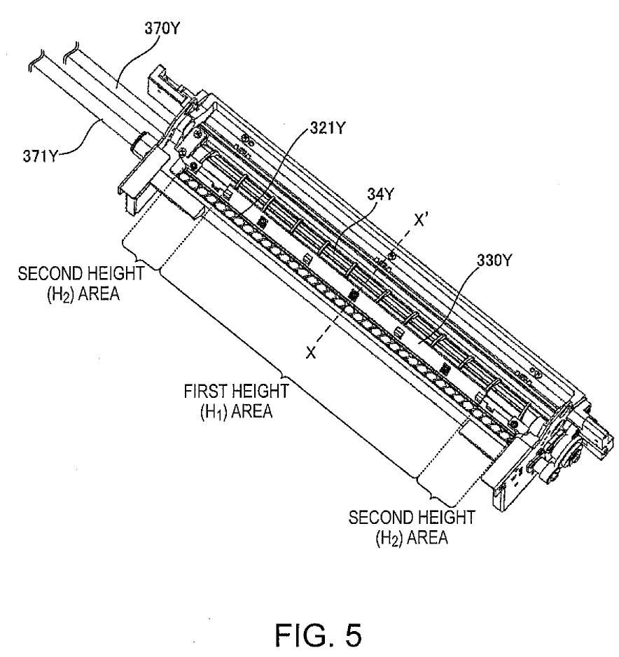

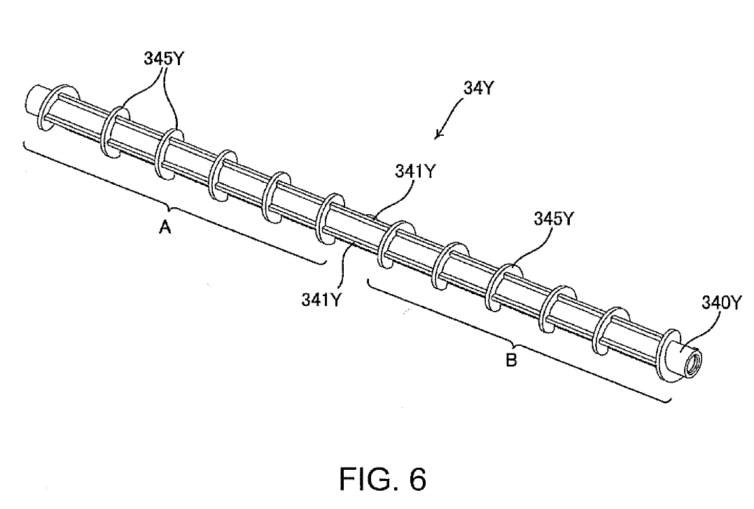

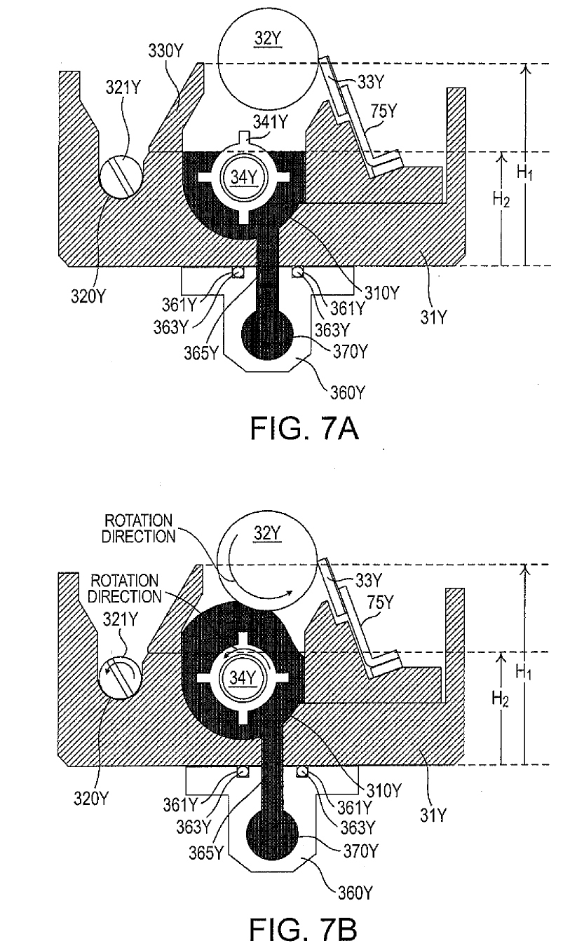

The detailed configuration of the developer container used in the developing device and the image forming apparatus according to the embodiment of the invention will be described now. FIG. 5 is a perspective view illustrating the developer container used in the embodiment and a relevant configuration thereof, FIG. 6 is a perspective view illustrating the auger used in the embodiment, and FIGS. 7A and 7B are diagrams illustrating a state where the developing device according to the embodiment is deactivated and a state where the developing device is activated, respectively.

FIGS. 5 to 7B, reference numeral 31Y represents a developer container, reference numeral 32Y represents an anilox roller, reference numeral 33Y represents a control blade, reference numeral 75Y represents a control blade holding member, reference numeral 34Y represents an auger, reference numeral 310Y represents a supply storage section, reference numeral 320Y represents a recovery storage section, reference numeral 321Y represents a recovery screw, reference numeral 330Y represents a partition section, reference numeral 340Y represents a shaft, reference numeral 341Y represents a longitudinal wing, reference numeral 345Y represents a spiral wing, reference numeral 360Y represents a liquid developer supply member, reference numeral 361Y represents a concave portion, reference numeral 363Y represents an O ring, reference numeral 365Y represents a liquid developer supply port, reference numeral 370Y represents a liquid developer supply pipe, and reference numeral 371Y represents a liquid developer recovery pipe.

FIG. 5 perspectively shows the top surface and the periphery of the developer container 31Y, where the anilox roller 32Y is excluded. As shown in FIGS. 5, 7A, and 7B, the space in the developer container 31Y is partitioned into two spaces by the partition section 330Y.

One space partitioned by the partition section 330Y is used as the supply storage section 310Y supplying the liquid developer and the other space is used as the recovery storage section 320Y recovering the liquid developer. The supply storage section 310Y and the recovery storage section 320Y are partitioned by the partition section 330Y so as to be parallel to each other in the longitudinal direction.

The auger 34Y is rotatably disposed in the supply storage section 310Y and the liquid developer stored in the supply storage section 310Y is supplied to the anilox roller 32Y by allowing the auger 34Y to rotate at the time of operation of the device or apparatus. The supply storage section 310Y and the liquid developer supply pipe 370Y are connected to each other and thus the supply of the liquid developer to the supply storage section 310Y is carried out by the liquid developer supply pipe 370Y.

The recovery screw 321Y is rotatably disposed in the recovery storage section 320Y and the liquid developer not used for the development or the carrier dropped from the cleaning blades such as the image carrier squeeze roller cleaning blades 14Y and 14Y′ are recovered by allowing the recovery screw 321Y to rotate at the time of operation of the device or apparatus.

The recovery storage section 320Y and the liquid developer recovery pipe 371Y are connected to each other and the liquid developer is transported to one end of the recovery storage section 320Y connected to the liquid developer recovery pipe 371Y by allowing the recovery screw 321Y to rotate. The liquid developer recovered in the recovery storage section 320Y is guided to a liquid developer recycling mechanism not shown by the liquid developer recovery pipe 371Y.

The partition section 330Y includes a first height (H₁) area and a second height (H₂) area different in the longitudinal direction. In this embodiment, the first height (H₁) area is set in the center portion of the partition section 330Y and the second height (H₂) area is set in both end portions of the partition section 330Y. Here, the first height (H₁) is greater than the second height (H₂).

The first height (H₁) area of the partition section 330Y serves to raise the liquid level of the liquid developer by blocking the liquid developer flowing to the recovery storage section 320Y with the rotation of the auger 34Y at the time of operation of the device or apparatus. That is, the first height (H₁) area is provided to transport the liquid developer to the anilox roller 32Y from the auger 34Y only when the auger 34Y rotates.

The second height (H₂) area of the partition section 330Y determines the liquid level of the liquid developer in the supply storage section 310Y at the time of the deactivation of the device or apparatus. At the time of the activation of the device or apparatus, the second height (H₂) area serves as a path for allowing the liquid developer normally supplied to the supply storage section 310Y from the liquid developer supply pipe 370Y to flow in the recovery storage section 320Y.

The second height (H₂) area of the partition section 330Y serves to determine the liquid level of the liquid developer in the supply storage section 310Y at the time of the deactivation of the device or apparatus, thereby preventing the anilox roller 32Y from being immersed in the liquid developer at the time of the deactivation of the device or apparatus.

When the anilox roller is immersed in the liquid developer at the time of the deactivation of the device or apparatus and an image forming operation is not performed for a long time, the toner component of the liquid developer may be secured to the anilox roller at the interface between the surface of the anilox roller and the surface of the liquid developer. In this case, at the time of restarting the device or apparatus, local unevenness in amount of liquid developer applied onto the developing roller 20Y is caused due to the toner component secured to the anilox roller. Then, the uneven amount of applied liquid developer may be reflected in an image at the time of forming the image. Accordingly, by employing the configuration according to this embodiment, the anilox roller is separated from the liquid developer at the time of deactivation of the device or apparatus.

FIG. 6 perspectively shows the detailed structure of the auger 34Y disposed in the developer controller 31Y shown in FIG. 5. Two types of wings of the longitudinal wing 341Y and the spiral wings 345Y used to transport the liquid developer in the supply storage section 310Y are provided around the auger 34Y disposed in the supply storage section 310Y. The longitudinal wing 341Y serves to transport the liquid developer in the peripheral direction of the auger 34Y and the spiral wings 345Y serve to transport the liquid developer in the longitudinal direction of the auger 34Y.

The longitudinal wing 341Y raises the liquid level of the liquid developer to supply the liquid developer to the anilox roller 32Y at the time of rotation of the auger 34Y.

In FIG. 6, the spiral wings 345Y belonging to area A and the spiral wings 345Y belonging to area B are different from each other in the revolving direction of the spirals and thus can transport the liquid developer in different directions in area A and area B.

The liquid developer is supplied to the supply storage section 310Y from the liquid developer supply port 365Y located substantially at the center in the longitudinal direction of the supply storage section 310Y through the liquid developer supply pipe 370Y. At the time of rotation of the auger 34Y, the liquid developer supplied from the liquid developer supply port 365Y is transported from the center in the longitudinal direction to the end portions by the spiral wings 345Y. In this way, since the liquid developer is supplied substantially from the center of the supply storage section 310Y and is transported to both ends in the longitudinal direction by the spiral conic auger 34Y, the liquid level of the liquid developer is kept uniform over the entire supply storage section 310Y at the time of activation of the device or apparatus and thus the toner is stably transported from the auger 34Y to the anilox roller 32Y.

FIGS. 7A and 7B show a section taken along line X-X′ of FIG. 5. FIG. 7A shows a state where the developing device is deactivated and FIG. 7B shows a state where the developing device is activated.

As shown in FIG. 7A, at the time of deactivation of the device, the liquid level of the liquid developer in the supply storage section 310Y is equal to the second height (H₂) of the partition section 330Y and thus the anilox roller 32Y is not immersed in the liquid developer. On the contrary, as shown in FIG. 7B, with the rotation of the auger 34Y at the time of activation of the device, the liquid level of the liquid developer is raised in the first height (H₁) area of the partition section 330Y by an area blocking effect and in the second height (H₂) area, the liquid developer flows from the supply storage section 310Y to the recovery storage section 320Y, whereby the liquid level is substantially equal to the second height (H₂).

Since the liquid developer supply member 360Y provided with the liquid developer supply port 365Y is attached to the developer container 31Y in a drip-proof manner by the use of the O ring 363Y in the concave portion 361Y, the liquid developer is supplied from the liquid developer supply port 365Y to the supply storage section 310Y. The liquid developer supply port 365Y is located in the vicinity of the center in the longitudinal direction of the supply storage section 310Y and thus the liquid developer supplied from the liquid developer supply port 365Y is transported to both ends of the supply storage section 310Y with the rotation of the auger 34Y by the effect of the spiral wings 345Y at the time of activation of the device. Since the liquid developer supply port 365Y is located at the position corresponding to the first height (H₁) area of the partition section 330Y, the above-mentioned transport of the liquid developer is carried out.

In this embodiment, at the time of activation of the device, since the liquid developer in the second height (H₂) area located at both end portions of the supply storage section 310Y flows from the supply storage section 310Y to the recovery storage section 320Y, the liquid level is substantially equal to the second height (H₂). Accordingly, the amount (the thickness) of liquid developer applied to both end portions of the developing roller 20Y is reduced, thereby suppressing the formation of a liquid ring as much as possible.

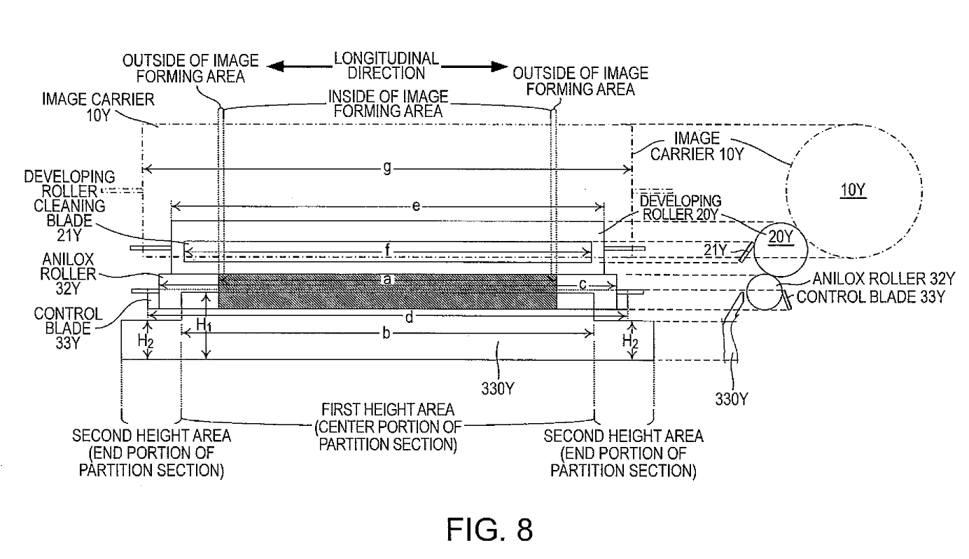

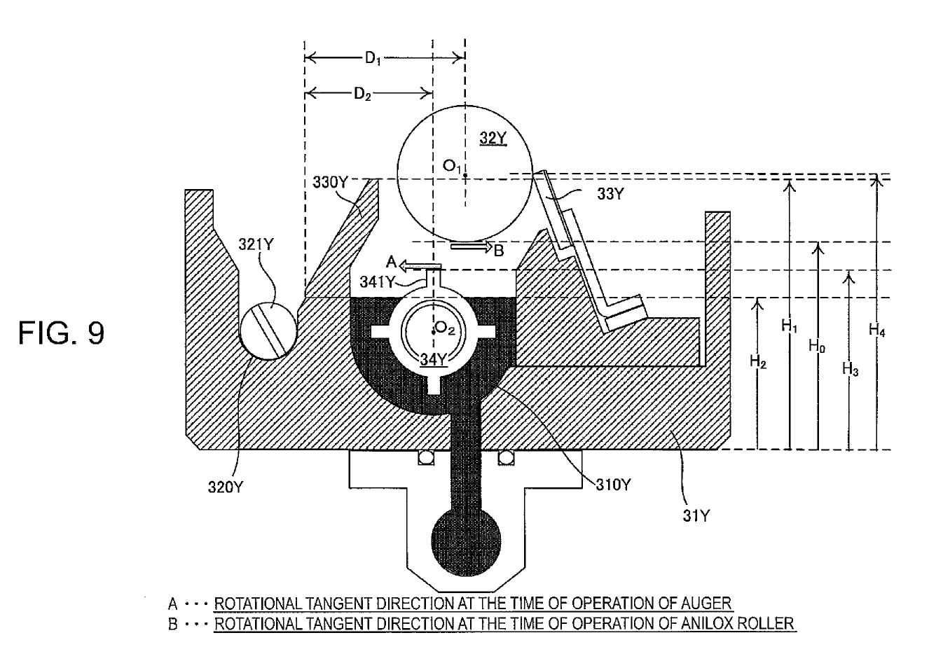

The details of the size relation of the elements used in the developing device and the image forming apparatus according to this embodiment will be described now. FIG. 8 is a diagram illustrating a longitudinal size relation of the rollers and the like in the developing device according to the embodiment and FIG. 9 is a diagram illustrating sectional size relation of the developer container in the developing device according to the embodiment.

FIG. 8 shows side views in the longitudinal direction (left) and sectional views (right) of the image carrier 10Y, the developing roller 20Y, the developing roller cleaning blade 21Y, the anilox roller 32Y, and the control blade 33Y, and the partition section 330Y in corresponding manner. Reference signs a to g in FIG. 8 represent lengths, where a represents the length of the groove area of the anilox roller 32Y, b represents the length in the longitudinal direction of the first height area of the partition section 330Y, c represents the length in the longitudinal direction of the anilox roller 32Y, d represents the length in the longitudinal direction of the control blade 33Y, e represents the length in the longitudinal direction of the developing roller, f represents the length in the longitudinal direction of the developing roller cleaning blade 21Y, and g represents the length in the longitudinal direction of the image carrier 10Y.

FIG. 9 shows a section taken along line X-X′ of FIG. 5. FIG. 9 shows the size relation of the developer container 31Y, the auger 34Y, the anilox roller 32Y, and the control blade 33Y. In FIG. 9, reference sign H₀ represents the height of the lowermost surface of the anilox roller 32Y, H₁ represents the first height of the partition section 330Y, H₂ represents the second height of the partition section 330Y, H₃ represents the height of the outermost periphery (the outermost periphery including up to the longitudinal wing 341Y) of the auger 34Y, and H₄ represents the height of the position where the anilox roller 32Y comes in contact with the control blade 33Y. In FIG. 9, reference sign D₁ represents the distance between the rotation center O₁ of the anilox roller 32Y and the partition section 330Y and D₂ represents the distance between the rotation center O₂ of the auger 34Y and the partition section 330Y.

The size relation according to the embodiment will be described now.

In the partition section 330Y, the first height (H₁) area and the second height (H₂) areas are formed in the center portion and the end portions in the longitudinal direction thereof. The first height (H₁) area in the center portion is higher than the second height (H₂) in the end portions. The length (b) of the first height (H₁) area in the longitudinal direction is set to be equal to or greater than the length (a) of the groove area on the outer periphery of the anilox roller 32Y.

When b<a is set, an area where the second height (H₂) of the partition section 330Y overlaps with the groove area of the anilox roller 32Y is formed and the liquid developer is not transported to the groove area of the anilox roller 32Y in the area. Accordingly, by employing the above-mentioned configuration, it is possible to transport the liquid developer to the entire groove area of the anilox roller 32Y.

In this embodiment, by selecting the optimal size relation depending on the kind of the liquid developer and the like from the relation of b≧a, it is possible to suppress the amount of liquid developer applied to both end portions of the developing roller 20Y, thereby suppressing the formation of a liquid ring as much as possible.

The length (c) in the longitudinal direction of the anilox roller 32Y is set to be greater than the length (b) in the longitudinal direction of the first height (H₁) area of the partition section 330Y. The allowable length range of the developer container 31Y is limited in view of volume. However, by setting the relation of c>b, the length of the second height (H₂) area of the partition section 330Y can be secured sufficiently broad, thereby allowing the liquid developer to smoothly flow from the supply storage section 310Y to the recovery storage section 320Y. In other words, in order to allow the liquid developer having certain viscosity to smoothly flow from the supply storage section 310Y to the recovery storage section 320Y, the length of the second height (H₂) area should be secured greater than a predetermined value. In this case, when c≦b is set, the width of the developer container 31Y should be increased to secure the length of the second height (H₂) area, thereby increasing the size of the device. When c≦b is set, the liquid developer is supplied up to the unnecessary portion of the anilox roller 32Y, thereby causing a liquid ring. Accordingly, by setting c>b, the formation of the liquid ring can be suppressed as much as possible.

The length (d) in the longitudinal direction of the control blade 33Y is set to be greater than the length (c) in the longitudinal direction of the anilox roller 32Y. When d<c is set and thus the length in the longitudinal direction of the control blade 33Y is smaller than the length in the longitudinal direction of the anilox roller 32Y, a large amount of liquid developer in the end portions of the anilox roller 32Y that cannot be scrubbed out by the control blade 33Y is applied to the developing roller 20Y, thereby enhancing the consumption of liquid developer. The surplus liquid developer in the roller end portions causing the liquid ring can be easily formed, which can be prevented by setting d>c.

The length (e) in the longitudinal direction of the developing roller 20Y is set to be smaller than the length (c) in the longitudinal direction of the anilox roller 32Y and is set to be greater than the length (a) of the groove area of the anilox roller 32Y. That is, the relation of c>e>a is set.

When e≦c is set, the liquid developer attached to the end surfaces of the anilox roller 32Y is transferred to the developing roller 20Y to form a liquid ring on the developing roller 20Y, thereby enhancing the consumption of liquid developer. It can be prevented by setting c>e.

When a≧e is set, the liquid developer is transported from the anilox roller 32Y to the side surface (end surface) of the developing roller 20Y. When the liquid developer is once attached to the side surface of the developing roller 20Y, it can hardly be cleaned. Accordingly, it can be prevented by setting a>e.

The length (f) in the longitudinal direction of the developing roller cleaning blade 21Y is set to be smaller than the length (e) in the longitudinal direction of the developing roller 20Y and is set to be greater than the length (a) of the groove area in which grooves are formed on the outer periphery of the anilox roller 32Y. By setting f>a, it is possible to clean the entire application area on the developing roller 20Y.

The height (H₀) of the lowermost surface of the anilox roller 32Y is set to be greater than the second height (H₂) and smaller than the first height (H₁). According to this configuration, the liquid level of the liquid developer raised with the rotation of the auger 34Y becomes higher than the lower surface of the anilox roller 32Y at the time of activation of the device, whereby the liquid developer is properly transported from the auger 34Y to the anilox roller 32Y. Accordingly, since the first height (H₁) area of the partition section 330Y, that is, the area in which the liquid level can be raised with the rotation of the auger 34Y, is located in the center portion having the groove area of the anilox roller 32Y, it is possible to properly transport the liquid developer to the anilox roller 32Y.

The length (g) in the longitudinal direction of the image carrier 10Y is set to be greater than the length (e) in the longitudinal direction of the developing roller 20Y. For example, when the length in the longitudinal direction of the image carrier 10Y is smaller than the length in the longitudinal direction of the developing roller 20Y, the liquid developer may be transported from the developing roller 20Y to the side surface (end surface) of the image carrier 10Y. When the liquid developer is attached to the side surface of the image carrier 10Y, it can hardly be cleaned. Accordingly, it can be prevented by the above-mentioned setting.

In this embodiment, the second height (H₂) is set to be smaller than the height (H₀) of the lowermost surface of the anilox roller 32Y.

The second height (H₂) area of the partition section 330Y has a function of determining the liquid level of the liquid developer in the supply storage section 310Y. When the second height (H₂) of the partition section 330Y is greater than the height of the lowermost surface of the anilox roller 32Y, the anilox roller 32Y contacts with the liquid developer at the time of not performing a printing operation. Then, when the printing operation is not performed for a long time, the liquid developer may be attached to the anilox roller 32Y at the boundary between the surface of the anilox roller 32Y and the surface of the liquid developer. When the printing operation is restarted in this state, the shape of the boundary may be reflected in an image. Accordingly, it is preferable that the anilox roller 32Y is separated from the liquid level of the liquid developer at the time of not performing the printing operation, thereby setting H₂<H₀.

The first height (H₁) is set to be greater than the height (H₀) of the lowermost surface of the anilox roller 32Y. By this setting, the liquid level of the liquid developer that can be raised by the auger 34Y is higher than the lower surface of the anilox roller 32Y and thus the liquid developer is properly transported from the auger 34Y to the anilox roller 32Y.

The second height (H₂) area of the partition section 330Y is disposed in the end portions in the longitudinal direction of the partition section 330Y. Accordingly, since the first height (H₁) area, that is, the area in which the liquid level can be raised by the auger 34Y, is located in the center portion having the carved portion (groove area) of the anilox roller 32Y, it is possible to properly transport the liquid developer to the anilox roller 32Y.

The height (H₄) of the position where the anilox roller 32Y comes in contact with the control blade 33Y is set to be greater than the second height (H₂). When the liquid level of the liquid developer at the time of not performing a printing operation (deactivation) which is defined by the second height (H₂) is greater than the height (H₄) of the position where the anilox roller 32Y comes in contact with the control blade 33Y, the liquid developer flows out of the grooves of the anilox roller 32Y at the contact position of the anilox roller 32Y and the control blade 33Y at the time of not performing a printing operation (at the time of deactivation of the device). By setting H₄>H₂, it can be prevented. When the liquid developer is mixed into the right area by the control blade 33Y in the developer container 31Y, the liquid developer may stay there, which can be prevented by the above-mentioned configuration.

The height (H₃) of the outermost periphery of the auger 34Y is set to be greater than the second height (H₂). Accordingly, it is possible to enhance the transport ability of the liquid developer from the auger 34Y to the anilox roller 32Y.

The liquid developer supply port 365Y is disposed at a position corresponding to the first height (H₁) area of the partition section 330Y, by locating the liquid developer supply port 365Y in the vicinity of the center in the longitudinal direction of the supply storage section 310Y. When the liquid developer supply port is located in the second height (H₂) area, the liquid developer flows from the second height (H₂) area to the recovery storage section 320Y before the liquid developer reaches the entire supply storage section 310Y. Accordingly, the liquid developer supply port 365Y is preferably disposed at the position corresponding to the first height (H₁) area.

In the partition section 330Y, the first height (H₁) is set to be greater than the second height (H₂) and the liquid level of the liquid developer at the time of deactivation is set to be smaller than the height of the lowermost surface of the anilox roller 32Y. At the time of activation, the rotational tangent direction of the uppermost surface of the auger 34Y is directed to the partition section 330Y and the rotational tangent direction of the lowermost surface of the anilox roller 32Y is directed to get apart from the partition section 330Y. In this state, the liquid developer is supplied from the auger 34Y to the anilox roller 32Y. Here, the rotation tangent direction is defined as a tangent direction of the rotation direction shown in FIG. 7B.

According to this configuration, it is possible to supply the liquid developer, which could be blocked by the partition section 330Y, to the anilox roller 32Y and it is also possible to effectively raise the liquid level by setting the rotational tangent direction of the auger 34Y as described above. In this case, when the liquid developer is supplied to the anilox roller 32Y, it is possible to suppress the amount of liquid developer applied to both end portions of the developing roller 20Y, thereby suppressing the formation of a liquid ring as much as possible.

The distance (D₂) between the rotation center of the auger 34Y and the partition section is set to be smaller than the distance (D₁) between the rotation center of the anilox roller 32Y and the partition section. Accordingly, by setting the auger 34Y to be closer to the partition section 330Y, the effect of raising the liquid level of the liquid developer can be enhanced, thereby properly supplying the liquid developer to the anilox roller 32Y.

The control blade 33Y is configured to come in trail contact with the anilox roller 32Y. When the control blade 33Y comes in counter contact with the anilox roller 32Y, the control blade 33Y is rapidly worn. Accordingly, by bringing the control blade 33Y into trail contact with the anilox roller 32Y, it is possible to enhance the durability.

The liquid level of the liquid developer in the supply storage section 310Y is determined by the second height (H₂). Accordingly, at the time of deactivation of the device, the anilox roller is separated from the liquid developer, thereby preventing the anilox roller 32Y from being immersed in the liquid developer.

The length (c) in the longitudinal direction of the anilox roller 32Y is set to be greater than the length (b) in the longitudinal direction of the first height (H₁). By setting c>b, it is possible to sufficiently secure the length of the second height (H₂) area of the partition section 330Y and thus to allow the liquid developer to smoothly flow from the supply storage section 310Y to the recovery storage section 320Y.

The second height (H₂) area of the partition section 330Y is disposed in the end portions in the longitudinal direction of the partition section 330Y. Accordingly, since the first height (H₁) area, that is, the area in which the liquid level can be raised by the auger 34Y, is located in the center portion having the carved portion (groove area) of the anilox roller 32Y, it is possible to properly transport the liquid developer to the anilox roller 32Y.

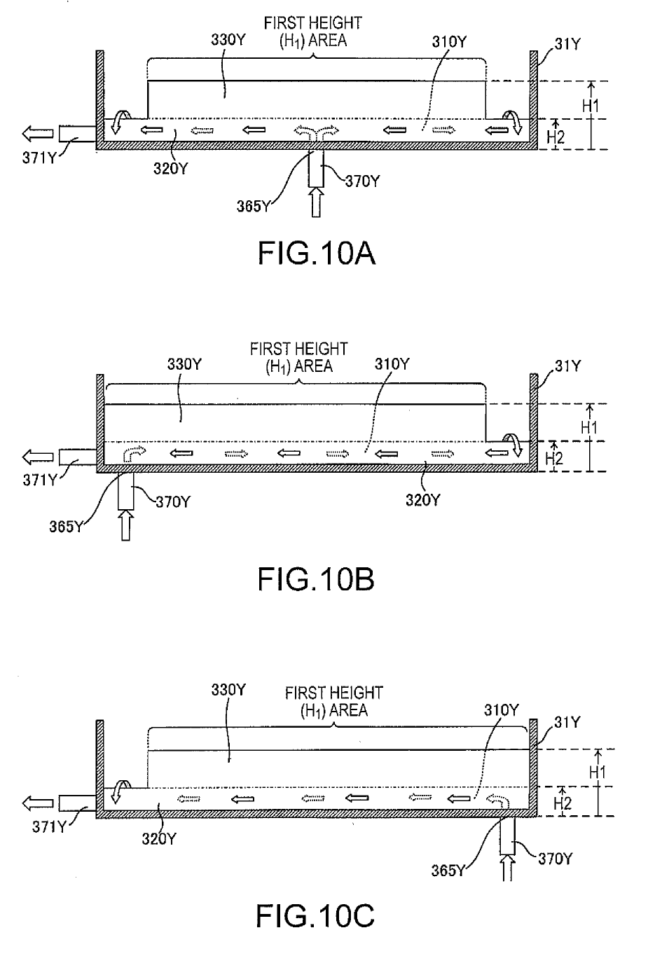

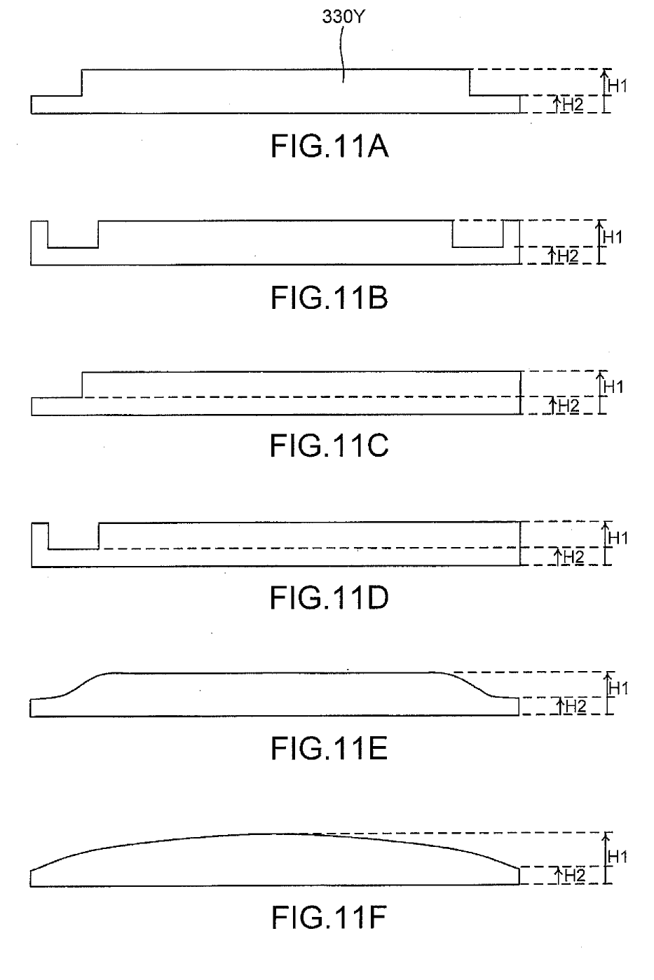

Another embodiment of the invention will be described now. FIGS. 10A, 10B, and 10C are diagrams schematically illustrating various types of partitioning the supply storage section and the recovery storage section from each other in the developer container. FIGS. 11A to 11F are diagrams illustrating various types of partition sections in the developing device and the image forming apparatus according to this embodiment of the invention.

FIGS. 10A, 10B, and 10C are diagrams schematically illustrating the developer container 31Y and show a flow of liquid developer in the supply storage section 310Y and the recovery storage section 320Y partitioned by the partition section 330Y. In FIGS. 10A, 10B, and 10C, the rear side of the partition section 330Y serves as the supply storage section 310Y and the front side of the partition section 330Y serves as the recovery storage section 320Y. In FIGS. 10A, 10B, and 10C, the dotted arrows indicate a flow of liquid developer in the supply storage section 310Y and the solid arrows indicate a flow of liquid developer in the recovery storage section 320Y.

FIG. 10A shows a flow of liquid developer according to the above-mentioned embodiment. At the time of activation of the device, the liquid level of the liquid developer supplied from the liquid developer supply port 365Y to the supply storage section 310Y is raised in the first height (H₁) area with the rotation of the auger 34Y not shown and the liquid developer goes over the partition section 330Y to flow from the supply storage section 310Y to the recovery storage section 320Y in the second height (H₂) area. The liquid developer supplied from the center of the supply storage section 310Y is transported to the left and right sides of the drawing by the auger 34Y.

In the recovery storage section 320Y, the liquid developer is transported from the left to the right in the drawing by the recovery screw 321Y not shown and is guided from the liquid developer recovery pipe 371Y to a developer recycling mechanism not shown.

FIG. 10B shows a flow of liquid developer according to another embodiment. In FIG. 10B, the liquid developer is supplied from the liquid developer supply port 365Y to the supply storage section 310Y in the left side of the drawing. With the rotation of the auger 34Y not shown, the liquid developer is transported from the left to the right in the drawing. With the rotation of the auger 34Y, the liquid level of the liquid developer is raised in the first height (H₁) area and the liquid developer is transported from the supply storage section 310Y to the recovery storage section 320Y in the second height (H₂) area which is the right side in the drawing. In the recovery storage section 320Y, the liquid developer is transported from the right to the left in the drawing by the recovery screw 321Y not shown. Since the auger 34Y used in this embodiment only transports the liquid developer from one side to the other side, the spiral directions of the spiral wings 345Y are the same.

FIG. 10C shows a flow of liquid developer according to another embodiment. In FIG. 10C, the liquid developer is supplied from the liquid developer supply port 365Y to the supply storage section 310Y in the right side of the drawing. With the rotation of the auger 34Y not shown, the liquid developer is transported from the right to the left in the drawing. With the rotation of the auger 34Y, the liquid level of the liquid developer is raised in the first height (H₁) area and the liquid developer is transported from the supply storage section 310Y to the recovery storage section 320Y in the second height (H₂) area which is the left side in the drawing. In the recovery storage section 320Y, the liquid developer is transported from the right to the left in the drawing by the recovery screw 321Y not shown. Since the auger 34Y used in this embodiment only transports the liquid developer from one side to the other side, the spiral directions of the spiral wings 345Y are the same.

In any embodiment, the liquid developer supply port 365Y is disposed at a position corresponding to the first height (H₁) area of the partition section 330Y. Accordingly, it is possible to efficiently transport the liquid developer.

When the configuration shown in FIG. 10B is compared with the configuration shown in FIG. 10C, the configuration shown in FIG. 10B is more preferable. When the liquid developer recovered from the developing roller 20Y not shown to the recovery storage section 320Y has high concentration, the liquid developer in the recovery storage section 320Y is not made to flow well due to the high-viscosity liquid developer even with the recovery screw 321Y in the configuration shown in FIG. 10C. However, in the configuration shown in FIG. 10B, since the liquid developer in the supply storage section 310Y normally flows in the recovery storage section 320Y, the high-viscosity liquid developer is pushed by the liquid developer from the supply storage section 310Y, thereby making a preferable flow in the recovery storage section 320Y.

As shown in FIGS. 10A, 10B, and 10C, various flows of liquid developer can be made in the supply storage section 310Y and the recovery storage section 320Y. Variations of the partition section 330Y can be suggested variously as shown in FIGS. 11A to 11F. In FIGS. 10A, 10B, and 10C, H₁ represents the first height of the partition section 330Y and H₂ represents the second height of the partition section 330Y.

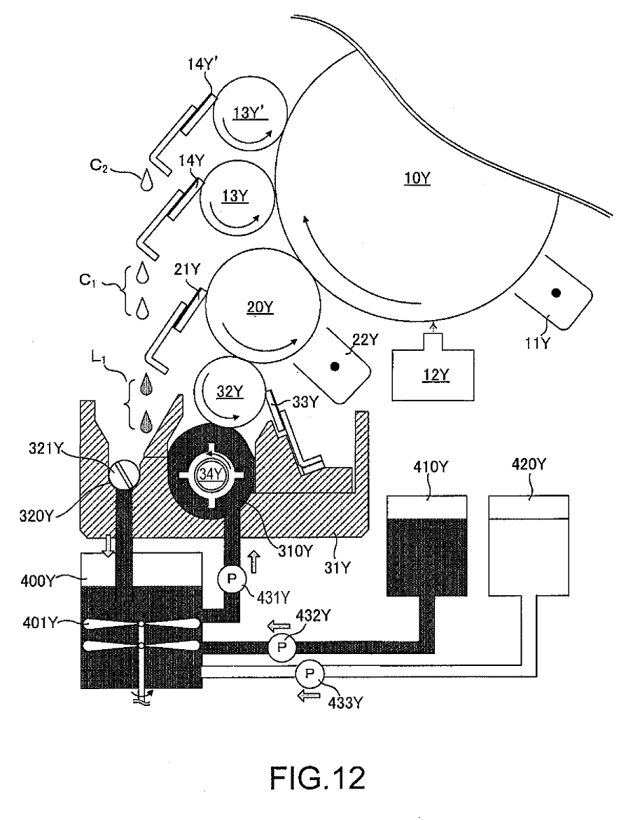

A flow of liquid developer outside the developer container will be described now. FIG. 12 is a diagram schematically illustrating a flow of liquid container flowing in the developer container and a flow of liquid developer flowing out of the developer container. In FIG. 12, reference numeral 400Y represents a concentration control tank, reference numeral 401Y represents an agitation unit, reference numeral 410Y represents a high-concentration toner tank, reference numeral 420Y represents a carrier tank, and reference numerals 431Y to 433Y represent pumps.

The concentration control tank 400Y is a tank for controlling the liquid developer about 20% of a solid toner concentration to be supplied to the supply storage section 310Y of the developer container 31Y. The high-concentration toner tank 410Y is a tank storing high-concentration toner with about 20% or more of the solid toner concentration and the carrier tank 420Y is a tank storing undiluted carrier liquid.

The concentration control tank 400Y is supplied with high-concentration toner from the high-concentration toner tank 410Y. For this purpose, the pump 432Y is driven.

The concentration control tank 400Y is supplied with the undiluted carrier liquid from the carrier tank 4 by driving the pump 433Y.

The concentration control tank 400Y is provided with a toner concentration detector such as an optical sensor not shown. The concentration is detected by the toner concentration detector. Then, the ON and OFF states of the pumps 432Y and 433Y are controlled by a controller not shown so that the concentration of liquid developer in the concentration control tank 400Y is appropriate. By driving the agitation unit 401Y disposed in the concentration control tank 400Y, the liquid developer in the concentration control tank 400Y is agitated.

At the time of activation of the device, the liquid developer is always supplied from the concentration control tank 400Y to the supply storage section 310Y by the pump 431Y. With the rotation of the recovery screw 321Y of the recovery storage section 320Y, the liquid developer in the recovery storage section 320Y is transported to the concentration control tank 400Y.

The recovery storage section 320Y serves to store the liquid developer transported from the supply storage section 310Y to the recovery storage section 320Y in the second height (H₂) area of the partition section 330Y and also serves as a reception tray of surplus developer C₁ and C₂ recovered by the cleaning blades 14Y and 14Y′ of the image carrier squeeze rollers 13Y and 13Y′. The recovery storage section 320Y also serves as a reception tray of the liquid developer L1 recovered by the developing roller cleaning blade 21Y and not used for the development. Since the recovery storage section 320Y of the developer container 31Y serves as the reception trays, it helps with the reduction of the number of elements.

According to the above-mentioned embodiment of the invention, it is possible to suppress the amount of liquid developer applied to both end portions of the developing roller 20Y, thereby suppressing the formation of a liquid ring as much as possible. As a result, it is also possible to reduce the consumption of liquid developer without contaminating the inside of the device or apparatus due to the drop of liquid developer from the liquid ring.

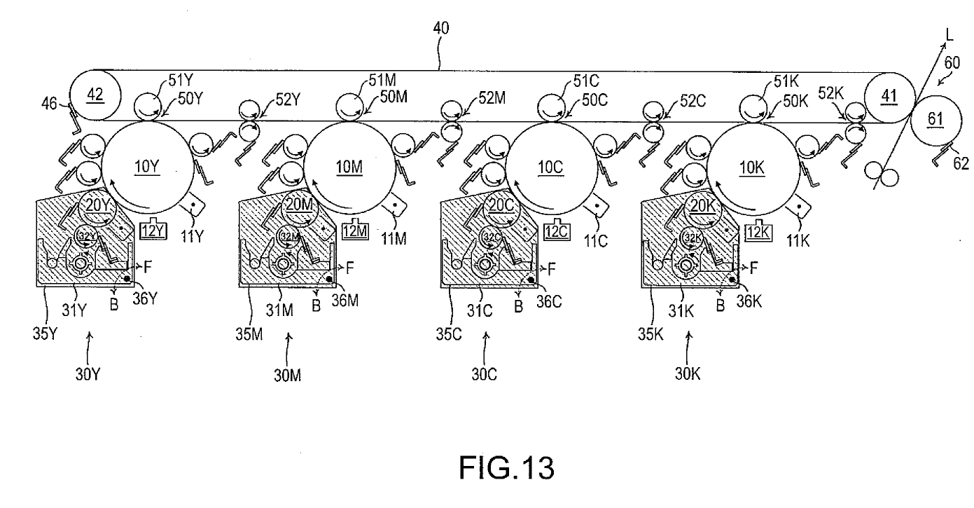

Another embodiment of the invention will be described now. FIG. 13 is a diagram illustrating primary elements of an image forming apparatus according to another embodiment of the invention. This embodiment is different from the above-mentioned embodiments, in that the developing devices 30Y, 30M, 30C, and 30K are unitized and the unitized developing devices can rotate about rotation pivots 36Y, 36M, 36C, and 36K, respectively. The developing rollers, the developing roller cleaning blades, the toner-compressing corona generators, the developer containers, and the anilox rollers as the primary elements of the developing devices are unitized to be interposed two developing unit plates 35Y, 35M, 35C, and 35K (only one is shown in FIG. 13).

The developing rollers 20Y, 20M, 20C, and 20K can be contacted with and separated from the image carriers 10Y, 10M, 10C, and 10K with the rotations of the unitized developing devices 30Y, 30M, 30C, and 30K about the rotation pivots 36Y, 36M, 36C, and 36K. According to this configuration, at the time of deactivation of the devices, it is possible to reduce the stress acting on a predetermined portion by separating the developing rollers from the image carriers. Of course, the image carriers are contacted with the developing rollers at the time of activation of the devices.

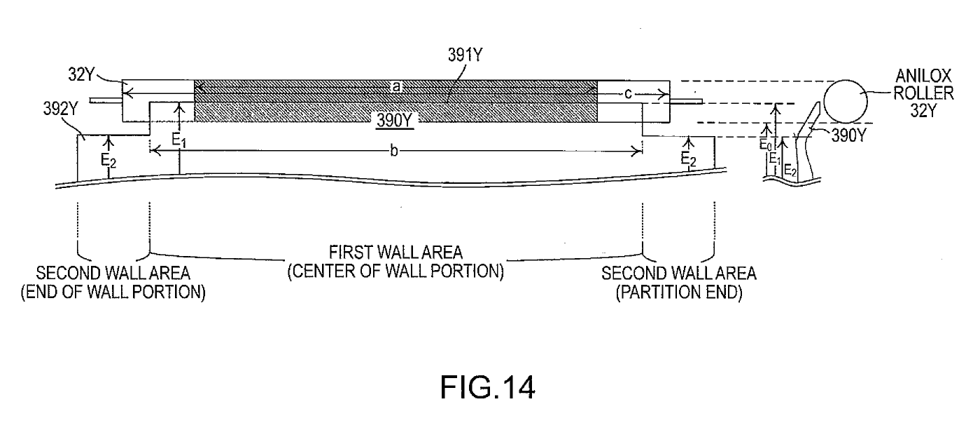

The details of a size relation of the elements used in the developing devices according to another embodiment will be described now. FIG. 14 is a diagram illustrating a size relation in the longitudinal direction of the rollers and the like in the developing device according to another embodiment of the invention. The partition section 330Y in the above-mentioned embodiments is referred to as a wall section 390Y in this embodiment, where the partition section is not different from the wall section. The wall section 390Y includes two areas of a first wall height portion 391Y in the center portion in the axis direction and second wall height portions 392Y in both end portions.

FIG. 14 shows a side view (left) and a sectional view (right) of the image carrier 10Y, the developing roller 20Y, and the wall section 390Y as viewed in the longitudinal direction. Reference signs a to c in FIG. 14 represent lengths, where a represents the length of the groove area of the anilox roller 32Y, b represents the length in the longitudinal direction of the first wall height portion 391Y of the wall section 390Y, and c represents the length in the longitudinal direction of the anilox roller 32Y.

In FIG. 14, reference sign E₀ represents the height of the lowermost surface of the anilox roller 32Y as viewed in the vertical direction, E₁ represents the height of the first wall height portion 391Y of the wall section 390Y as viewed in the vertical direction, and E₂ represents the height of the second wall height portion 392Y of the wall section 390Y as viewed in the vertical direction.

The size relation specific to this embodiment will be described now.

The wall section 390Y includes a height (E₁) area of the first wall height portion 391Y and a height (E₂) area of the second wall height portion 392Y in the center portion and the end portions in the longitudinal direction. The height (El) area of the first wall height portion 391Y in the center portion in the longitudinal direction is higher than the height (E₂) area of the second wall height portion 392Y in the end portions in the longitudinal direction. Here, the length (b) in the longitudinal direction of the height (E₁) area of the first wall height portion 391Y is set to be equal to or greater than the length (a) of the groove area on the outer periphery of the anilox roller 32Y.

When b<a is set, an area where the second height (E₂) area of the wall section 390Y and the groove area of the anilox roller 32Y overlap with each other is formed and the liquid developer is not transported to the groove area of the anilox roller 32Y in the overlapping area. Accordingly, by setting b≧a as described above, the liquid developer can be transported to the entire groove area of the anilox roller 32Y.

In this embodiment, by selecting the optimal size relation depending on the kind of the liquid developer from the relation of b≧a, it is possible to suppress the amount of liquid developer applied to both end portions of the developing roller 20Y, thereby suppressing the formation of a liquid ring as much as possible.

The length (c) in the longitudinal direction of the anilox roller 32Y is set to be greater than the length (b) in the longitudinal direction of the first height (E₁) area of the wall section 390Y. The allowable length range of the developer container 31Y is limited in view of volume. However, by setting the relation of c>b, the length of the second height (E₂) area of the wall section 390Y can be secured sufficiently broad, thereby allowing the liquid developer to smoothly flow from the supply storage section 310Y to the recovery storage section 320Y. In other words, in order to allow the liquid developer having certain viscosity to smoothly flow from the supply storage section 310Y to the recovery storage section 320Y, the length of the second height (E₂) area should be secured equal to or greater than a predetermined value. In this case, when c≦b is set, the width of the developer container 31Y should be increased to secure the length of the second height (E₂) area, thereby increasing the size of the device. When c≦b is set, the liquid developer is supplied up to the unnecessary portion of the anilox roller 32Y, thereby causing a liquid ring. Accordingly, by setting c>b, the formation of the liquid ring can be suppressed as much as possible.

The height (E₀) of the lowermost surface of the anilox roller 32Y is set to be greater than the height (E₂) of the second wall height portion 392Y and smaller than the height (E₁) of the first wall height portion 391Y. Accordingly, the liquid level of the liquid developer that is raised with the rotation of the auger 34Y is higher than the lower surface of the anilox roller 32Y at the time of activation of the device and thus the liquid developer is properly transported from the auger 34Y to the anilox roller 32Y. Accordingly, since the first height (E₁) area of the wall section 390Y, that is, the area in which the liquid level can be raised with the rotation of the auger 34Y, is located in the center portion having the groove area of the anilox roller 32Y, it is possible to properly transport the liquid developer to the anilox roller 32Y.

In this embodiment, the height (E₂) of the second wall height portion 392Y is set to be smaller than the height (E₀) of the lowermost surface of the anilox roller 32Y. The height (E₂) area of the second wall height portion 392Y of the wall section 390Y has a function of determining the liquid level of the liquid developer in the supply storage section 310Y. When the second height (E₂) of the wall section 390Y is greater than the height of the lowermost surface of the anilox roller 32Y, the anilox roller 32Y contacts with the liquid developer at the time of not performing a printing operation. Then, when the printing operation is not performed for a long time, the liquid developer may be attached to the anilox roller 32Y at the boundary between the surface of the anilox roller 32Y and the surface of the liquid developer. When the printing operation is restarted in this state, the shape of the boundary may be reflected in an image. Accordingly, it is preferable that the anilox roller 32Y is separated from the liquid surface of the liquid developer at the time of not performing the printing operation, thereby setting E₂<E₀.

The height (E₁) of the first wall height portion 391Y is set to be greater than the height (E₀) of the lowermost surface of the anilox roller 32Y. By this setting, the liquid level of the liquid developer that can be raised by the auger 34Y is higher than the lower surface of the anilox roller 32Y and thus the liquid developer is properly transported from the auger 34Y to the anilox roller 32Y.

The height (E₂) area of the second wall height portion 392Y of the wall section 390Y is disposed in the end portions in the longitudinal direction of the wall section 390Y. Accordingly, since the first height (E₁) area, that is, the area in which the liquid level can be raised by the auger 34Y, is located in the center portion having the carved portion (groove area) of the anilox roller 32Y, it is possible to properly transport the liquid developer to the anilox roller 32Y.

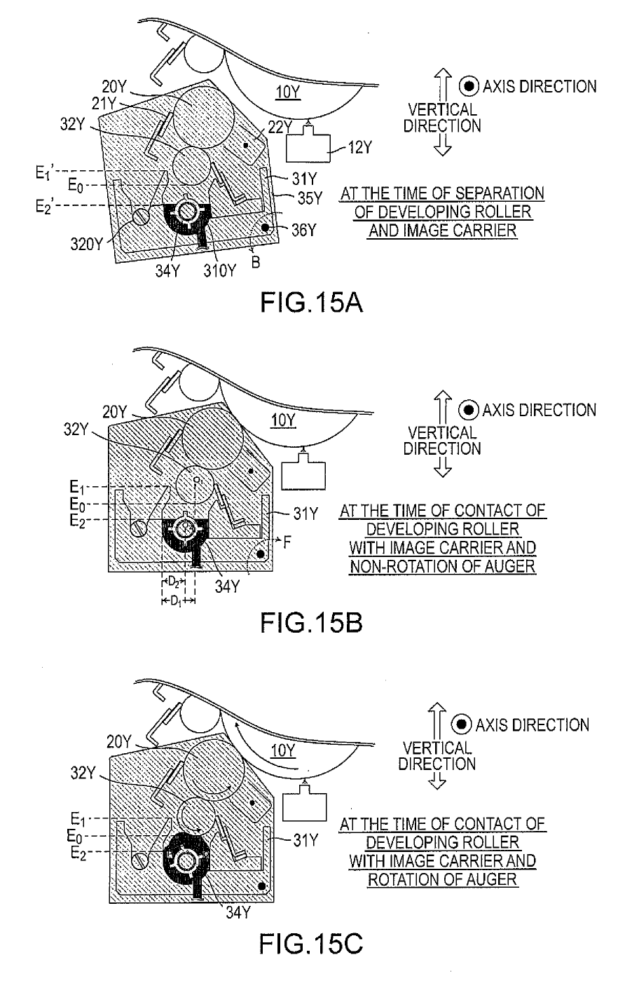

FIGS. 15A, 15B, and 15C are sectional views illustrating primary elements of the image forming section and the developing device according to another embodiment of the invention. Since the configurations of the image forming sections and the developing devices of the colors are equal to each other, the image forming section and the developing device of yellow (Y) will be representatively described. FIG. 15A shows a state where the developing roller 20Y is separated from the image carrier 10Y, FIG. 15B shows a state where the developing roller 20Y is in contact with the image carrier 10Y and the auger 34Y does not rotate, and FIG. 15C shows a state where the developing roller 20Y is in contact with the image carrier 10Y and the auger 34Y rotates. In FIGS. 15A to 15C, reference sign D₁ represents a distance between the rotation center O₁ of the anilox roller 32Y and the wall section 390Y and reference sign D₂ represents a distance between the rotation center O₂ of the auger 34Y and the wall section 390Y.

FIG. 15A shows a state where the developing device 30Y rotates in the direction of B about the rotation pivot 36Y. This state is taken at the time of complete deactivation of the device. In this case, the height (E₀) of the lowermost surface of the anilox roller 32Y is set to be greater than the height (E₂′ ) of the second wall height portion 392Y and smaller than the height (E₁′) of the first wall height portion 391Y.

FIG. 15B shows a state where the developing device 30Y rotates in the direction of F about the rotation pivot 36Y, the developing roller 20Y comes in contact with the image carrier 10Y, and the auger 34Y does not rotate. This state is taken at the time of temporary deactivation of the device.

FIG. 15C shows a state where the developing device 30Y rotates in the direction of F about the rotation pivot 36Y, the developing roller 20Y comes in contact with the image carrier 10Y, and the auger 34Y rotates. This state is taken at the time of an image forming operation of the device.

As shown in FIGS. 15A, 15B, and 15C, the distance (D₂) between the rotation center of the auger 34Y and the wall section 390Y is set to be smaller than the distance (D₁) between the rotation center of the anilox roller 32Y and the wall section 390Y. According to this configuration, by allowing the auger 34Y to get close to the wall section 390Y, the effect of raising the liquid level of the liquid developer can be enhanced, thereby more properly supplying the liquid developer to the anilox roller 32Y. The rotational tangent direction of the upper surface of the auger 34Y in the vertical direction may be a direction (P) in which it gets close to the wall section 390Y or a direction (Q) in which it gets apart from the wall section 390Y.

According to this configuration, since the liquid developer does not come in contact with the anilox roller 32Y at the time of the deactivation of the image forming apparatus, it is possible to prevent the toner component of the liquid developer from cohering and adhering to the anilox roller 32Y and thus the line-like mark is not formed in the axis direction of the anilox roller 32Y, thereby not causing the deterioration in image quality due to the line-like mark.

According to the above-mentioned configuration, it is possible to suppress the amount of liquid developer applied to both end portions of the developing roller 20Y, thereby suppressing the formation of a liquid ring as much as possible. As a result, it is also possible to reduce the consumption of liquid developer without contaminating the inside of the device or apparatus due to the drop of liquid developer from the liquid ring.

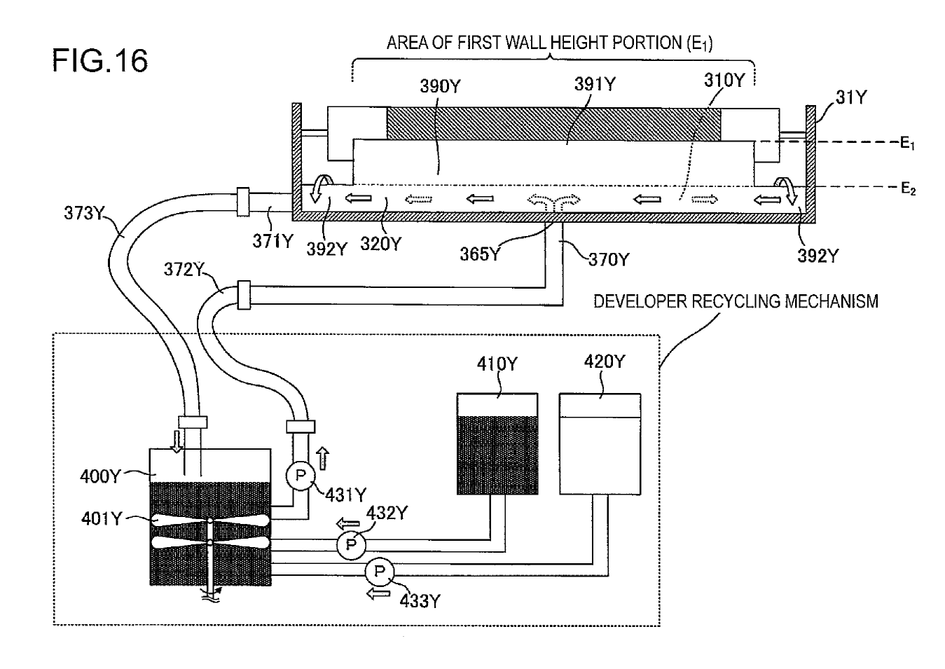

A flow of liquid developer outside the developer container according to another embodiment of the invention will be described now. FIG. 16 is a diagram illustrating a developer recycling mechanism according to another embodiment of the invention. Elements common to the above-mentioned embodiments are denoted by the same reference numerals as the above-mentioned embodiments.

In this embodiment, a liquid developer supply pipe 370Y is connected to a concentration control tank (concentration control storage section) 400Y through a liquid developer supply connection pipe 372Y and a liquid developer recovery pipe 371Y is connected to the concentration control tank (concentration control storage section) 400Y through a liquid developer recovery connection pipe 373Y. The liquid developer supply connection pipe 372Y and the liquid developer recovery connection pipe 373Y both employ a deformable pipe so as to cope with a rotational motion of the developing device about the rotation pivot 36Y.

The concentration control tank (concentration control storage section) 400Y is a tank used to control the liquid developer with about 20% as the concentration of solid toner powder to be supplied to the supply storage section 310Y of the developer container 31Y. A high-concentration toner tank (toner storage section) 410Y is a tank storing high-concentration toner with about 20% or more as the concentration of solid toner power and a carrier tank (carrier storage section) 420Y is a tank storing undiluted carrier liquid.

The developer recycling mechanism according to this embodiment operates in the same way as described in the above-mentioned embodiments. Accordingly, it is possible to suppress the amount of liquid developer applied to both end portions of the developing roller 20Y, thereby suppressing the formation of a liquid ring as much as possible. As a result, it is also possible to reduce the consumption of liquid developer without contaminating the inside of the device or apparatus due to the drop of liquid developer from the liquid ring.

Although various embodiments of the invention have been described above, embodiments obtained by properly combining the configurations of the embodiments are included in the scope of the invention.

The entire disclosure of Japanese Patent Application Nos: 2007-319140, filed Dec. 11, 2007 and 2008-268156, filed Oct. 17, 2008 are expressly incorporated by reference herein.

What is claimed is:

1. A developing device comprising:
a supply storage section that stores liquid developer including toner and carrier liquid;
an application roller that applies the liquid developer stored in the supply storage section;
a developing roller supplied with the liquid developer by the application roller;
a developing roller cleaning blade that comes in contact with the developing roller and removes the liquid developer supplied to the developing roller;
a recovery storage section that stores the liquid developer removed by the developing roller cleaning blade;
a wall portion configured to partition the supplied storage section and the recovery storage section and having a first wall height portion higher than a lower portion of the application roller in the vertical direction and a second wall height portion lower than the lower portion in the vertical direction; and
an auger that transports the liquid developer stored in the supply storage section.

2. The developing device according to claim 1, wherein the rotation center of the auger is closer to the wall portion than the rotation center of the application roller is.

3. The developing device according to claim 1, further comprising a control blade that comes in trail contact with the application roller to control an amount of liquid developer.

4. The developing device according to claim 1, wherein the axis-direction length of the application roller is greater than the length of the first wall height portion in the axis direction of the application roller.

5. The developing device according to claim 1, wherein the second wall height portion is disposed at ends in the axis direction of the application roller.

6. The developing device according to claim 1, wherein the application roller comes in contact with the developing roller.

7. A developing method comprising:
raising the liquid level of liquid developer stored in a supply storage section by rotation of an auger disposed in the supply storage section to bring the liquid developer into contact with an application roller and
transporting the liquid developer to a recovery storage section partitioned from the supply storage section by a wall portion.

8. The developing method according to claim 7, wherein the wall portion has a first wall height portion higher than the bottom surface of the application roller in the vertical direction and a second wall height portion lower than the bottom surface of the application roller in the vertical direction, the liquid developer is brought into contact with the application roller in the supply storage section corresponding to the first wall height portion, and the liquid developer is transported to the recovery storage section in the supply storage section corresponding to the second wall height portion.

9. The developing method according to claim 7, wherein an amount of liquid developer to be applied is controlled by a control blade coming in trail contact with the application roller.

10. The developing method according to claim 7, wherein the application roller applies the liquid developer onto a developing roller coming in contact with the application roller.

11. The developing method according to claim 7, wherein a rotational tangent direction of the top surface of the auger in the vertical direction is directed to the wall portion.

12. An image forming apparatus comprising:
an image carrying member that carries a latent image;
a charging unit that charges the image carrying member;
an exposure unit that forms the latent image on the image carrying member charged by the charging unit;
a developing unit that includes a developing roller, an application roller applying liquid developer onto the developing roller, a developing roller cleaning member removing the liquid developer applied onto the developing roller, and a supply storage section storing the liquid developer and developing the latent image formed on the image carrying member;
a transfer unit that transfer the developed image on the image carrying member to a transfer medium;
a recovery storage section that recovers the liquid developer removed by the developing roller cleaning member; and
a wall portion that partitions the supply storage section from the recovery storage section and that have a first wall height portion higher than the bottom surface of the application roller in the vertical direction and a second wall height portion lower than the bottom surface of the application roller in the vertical direction.

13. The image forming apparatus according to claim 12, further comprising a concentration control storage section that supplies the liquid developer to the supply storage section and that recovers the liquid developer stored in the recovery storage section to control the concentration of the liquid developer.

14. The image forming apparatus according to claim 12, further comprising:
a toner storage section that supplies the liquid developer, which includes toner and carrier liquid, to the concentration control storage section; and
a carrier storage section that stores the carrier liquid supplied to the concentration control storage section.

15. The image forming apparatus according to claim 12, further comprising an agitating portion that agitates the liquid developer stored in the concentration control storage section.
